(19) United States
(12) Patent Application Publication
(10) Pub. No.: US 2017/0055619 A1
(43) Pub. Date: Mar. 2, 2017

(54) Shovel Head Counterweight

(71) Applicant: SERE INDUSTRIES INC., Mission Viejo, CA (US)

(72) Inventor: Timothy M. Langan, Mission Viejo, CA (US)

(21) Appl. No.: 14/901,427

(22) PCT Filed: Jun. 26, 2014
(86) PCT No.: PCT/US2014/044466

§ 371 Date: Dec. 28, 2015

Related U.S. Application Data
(60) Provisional application No. 61/839,481, filed on Jun. 26, 2013.

(51) Int. Cl. A42B 3/04; A01B 1/02; A01B 1/22; F41H 1/04

(52) U.S. Cl. CPC A42B 3/0406; F41H 1/04; A01B 1/022; A01B 1/227

(57) ABSTRACT

A shovel head counterweight for a helmet has been described. The counterweight has a mass that acts to counterbalance other objects attached to a helmet, such as night vision goggles. The shape and thin profile of the counterweight distributes the mass across the surface of the helmet to decrease strain on the user's neck. In addition, the underside of the counterweight is contoured to snuggly fit against the curvatures of the helmet. The counterweight also has one or more fasteners for removably attaching the counterweight to the helmet. The fastener(s) can also be used to attach a bar for use as a shovel. The counterweight has a digging edge for shoveling and a concave underside for scooping dirt or other material.

This application claims priority to a U.S. Provisional Application Ser. No. 61/839,481, filed Jun. 26, 2013. All extrinsic materials identified herein are incorporated by reference in their entirety.

### FIELD OF THE INVENTION

The field of the invention is counterweights for helmets, more specifically, a shovel head multipurpose tool that can be used as a helmet counterweight and a shovel head.

### BACKGROUND

The background description includes information that may be useful in understanding the present invention. It is not an admission that any of the information provided herein is prior art or relevant to the presently claimed invention, or that any publication specifically or implicitly referenced is prior art.

Helmets are well known and are used in numerous industries to protect a user's head. Some examples include military personnel, miners, and construction workers, to name just a few. In some applications, various technology and tools may be attached to the helmet to provide additional functionality. For example, military personnel may attach a night vision goggle unit on the front of the helmet to enhance the user's vision in a dark environment. As another example, miners may attach a light source to the front of the helmet to light the inside of a mine. In yet another example, some extreme sport athletes attach video cameras to their helmets to record a sport event (e.g., sky diving, base jumping, bungee jumping, extreme skiing/snowboarding, etc.).

Some helmet attachments, such as night vision goggle units, can add significant weight to the helmet and can cause additional stress on the user's cervical spine and muscles. It would be advantageous to provide a helmet counterweight that decreases stress on the user's cervical spine and muscles.

Several embodiments of counterweights for helmets are disclosed in U.S. Pat. No. 8,458,821 (the '821 Patent). While the counterweight embodiments disclosed in the '821 Application are advantageous in many aspects, it would be beneficial to provide an improved counterweight that has additional functionality and further reduces stress on the user's cervical spine and muscles, especially while the user is in motion.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved multipurpose helmet counterweights.

### SUMMARY OF THE INVENTION

The inventive subject matter provides apparatus, systems and methods in which a helmet counterweight for counterbalancing a helmet attachment (e.g., night vision goggles, etc.) on a helmet is designed to induce minimal stress on the user's neck. In one aspect, the reduced neck stress is achieved by distributing the mass of the counterweight across a larger surface area of the helmet. By spreading the mass across a larger surface area, the moment of force (e.g., torque) vectors (relative to the user's neck) are also spread out. This helps to reduce stress on the user's neck, in part because the spread out vectors cancel or reduce one another. In another aspect of the inventive subject matter, the reduced neck stress is achieved by the counterweight's low profile, which reduces the distance of the mass to the neck. By keeping the mass closer to the user's neck, the torque on the neck is also reduced.

In some embodiments, the underside of the helmet counterweight has one or more curvatures that match the contours of regions or surfaces on the helmet. This helps to maintain a low profile since the counterweight can fit snuggly against the helmet.

In other aspects of some embodiments, the larger surface area of the counterweight is leveraged by shaping the counterweight as a shovel head, thus allowing the counterweight to function in two different capacities (as a helmet counterweight and as part of a shovel). In some embodiments, the counterweight is shaped with a broad end for digging and a narrower end where a bar with a handle can be attached. The broad end can have a sharp edge to help dig/cut into soil or other material.

In other aspects the helmet counterweight can be removably attached to the helmet at different locations on the helmet and in different orientations. This allows for greater counterbalance customization for different sizes of user's and for different helmet attachments having different weights and/or attachment positions. For example, a heavier helmet attachment may require the counterweight to be placed farther back on the helmet than for a lighter helmet attachment. As another example, the size and strength of the user's cervical-spine and linking muscles depends on anatomy and body type, and will vary from user to user. The repositionability of the counterweight allows each user to position and orient (e.g., rotate) the counterweight until maximum comfort is achieved. In some embodiments, the repositionability of the counterweight is provided by using hook and loop fasteners or other quick-release fasteners at different locations on the helmet. In addition, the curvatures and contours of the underside of the counterweight match (or are at least compatible with) different surfaces, regions, and/or portions of the helmet.

In some embodiments, the counterweight has a mass of 2.1 lbs, which is scientifically designed to properly counter balance a standard night vision goggles unit. The counterweight correctly relocates the weight distribution on the user's neck. Since body types and muscle structure are completely unique, additional counterweights having different masses can be used with the first counter weight (or instead of the first counterweight) with the same helmet. The interchangeability of counterweights provides greater user customization. In this manner, the user is provided with greater balance, stability, and tension relief on the cervical spine and muscles.

Military Personnel and Emergency First Responders such as Special Weapons and Tactics (“SWAT”) teams are among the primary groups that wear ballistic helmets and Night Vision Goggles (NVG's) for training and real life tactical missions. Those operators who work at night often require the use of NVG's, which allows images to be produced in levels of light approaching total darkness. NVG's typically weigh between 1.5 and 2 lbs. They attach to the front of the helmet and create a myriad of variable forces on the users' physiological and biomechanical functions. Those forces include the actual weight of the NVG, the weight and individual fit of the users helmet, along with the helmets positioning during use combined with the positioning of the NVG's and the weight of the gravitational force acting on the given body. Equally all weight influences are subject to, and combined with mass forces such as energy, velocity, acceleration and various forces acting on the body that express these variables dynamically as differential equations. The invention correctly calculates and addresses the mass properties of the dynamic variables by distributing a proportional weight across the rear surface area comprising of nearly ⅓ of the rear of the helmet. The positioning of our invention equally differs depending on the gravitational pull of the opposing body and forces. As a consequence it creates balance as opposed to imbalance. When these forces are not balanced properly muscular compensation is required by the user creating constant pressure on the metabolic and hemodynamic responses of the trapezius muscles.

The design is to produce a low profile, precision contour, personal fitting, multipurpose tool that attaches to a helmet by multiple and varying points of contact and unification. The specific contour is even with the helmet surface contour and when connected the pairing creates a uniquely significant 1 and 1000th inch separation to the surface area of the helmet. The tool can also be utilized as a separate detachable shovel, hammer, pick, hoe, nail puller, demolition axe, saw, ballistic protection, tripod platform and survival eating utensil. The designs weight displacement is critical for the counter balance of dissimilar anthropometric characteristics concerning height, weight, or for modified body types combined with unpredictable equipment suited for the size of the individual, or in reference to the special gear like NVG's worn for specific situations. Equally the design comprises three dynamic remarkable connection ports that allow for external connectors to attach. Similarly the dynamic curvature and remarkable shape of the tool offer unique solutions for digging and excavation.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows two isometric views of the major surfaces (e.g., top surface and bottom surface) of one embodiment of a shovel head counterweight.

FIG. 2 shows top, bottom, and side views of the shovel head counterweight of FIG. 1.

FIG. 3 shows the shovel head counterweight of FIG. 1 attached to a helmet.

FIG. 4 shows the shovel head counterweight and helmet of FIG. 3 worn by a user.

FIG. 5 shows the shovel head counterweight of FIG. 1 with a utility bar attached to the various universal fasteners of the shovel head counterweight in three different configurations.

FIG. 6 shows the utility bar attached with a shovel head counterweight in one embodiment and with a spear head in another embodiment.

FIG. 7 shows a close-up of the shovel head counterweight attached to a utility bar.

FIG. 8 shows the weight displacement physics of the shovel head counterweight.

FIG. 9 shows the shovel head counterweight attached to a helmet.

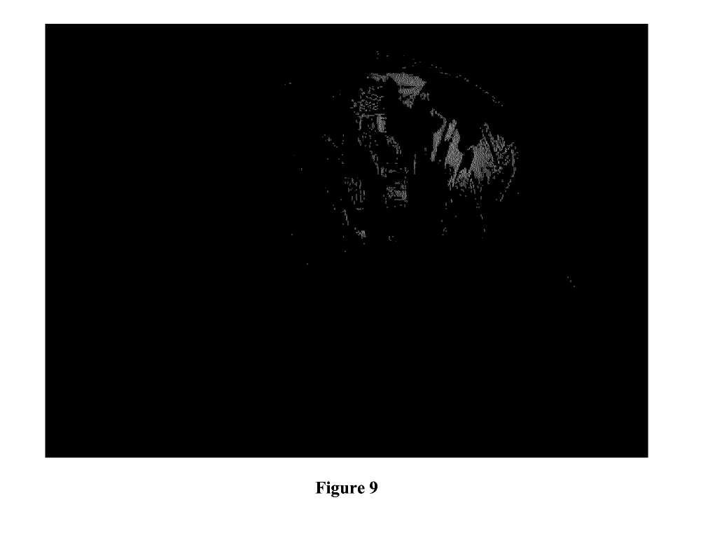

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The inventive subject matter provides apparatus, systems and methods in which a shovel head counterweight can be removably and repositionably secured to a helmet via a first universal fastener to counterbalance the weight of a helmet attachment (e.g., NVG) to reduce stress on the user's cervical spine and muscles. The counterweight is specifically designed with (i) a low center of mass relative to the outer surface of the helmet, and (ii) a distributed mass. As such, the counterweight reduces stress on the user's cervical spine and muscles, even while the user is in motion (e.g., jumping, running, turning, etc.).

The shovel head counterweight also has a second universal fastener for fastening a utility bar thereto. With the utility bar attached, the shovel head counterweight serves as a shovel head for excavating. The shovel head counterweight has a first edge and a concave-shaped body that are designed to improve excavating efficiency. The multi-functional aspect of the counterweight reduces the weight and number of tools that need to be carried by the user (e.g., emergency response personnel, campers, military personnel, etc.).

In some embodiments the shovel head counterweight has a third universal fastener for fastening the utility bar to the shovel head counterweight at a different orientation, to provide additional functionality (e.g., support stand for a rifle, camera, or scope).

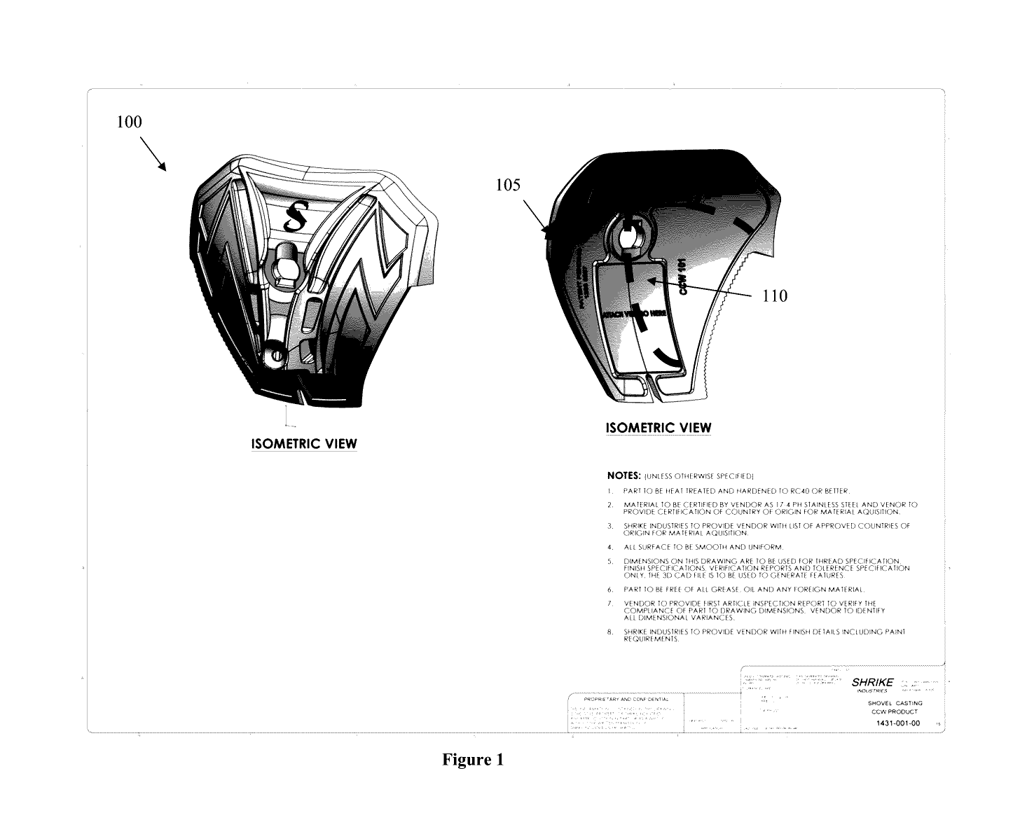

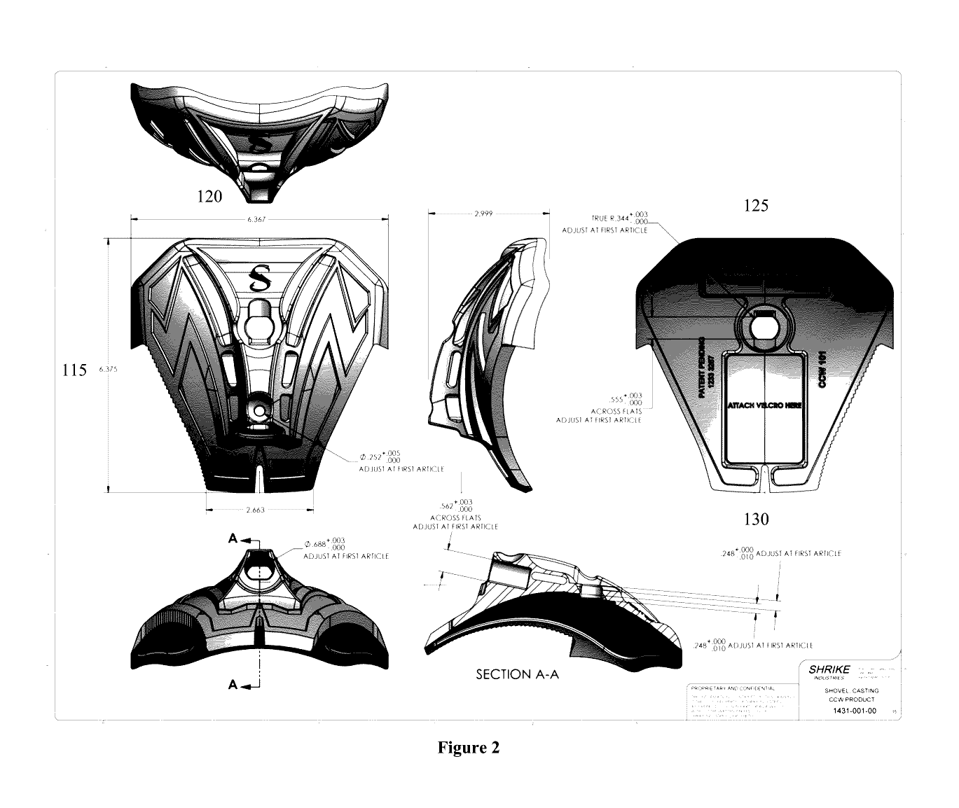

FIGS. 1 and 2 show various views of one embodiment of a shovel head counterweight 100. The shovel head counterweight 100 can be used to counterbalance a helmet attachment on a helmet. The underside surface of counterweight 100 has a first curvature 105 and a second curvature 110, indicated by the bold dotted lines. The shovel head counterweight 100 is a concave member that has a first major surface (top surface), a second major surface (underside surface), a length 115, and a width 120. It should be appreciated that a curvature of the width of the concave member is sized and dimensioned to match the first curvature of the helmet. In addition, a curvature of the length of the concave member can be sized and dimensioned to match the second curvature of the helmet. The width gradually decreases from a first end 125 of the length to a second end 130 of the length. Thus, it should be appreciated that the shovel head counterweight can contour to the curvature of the helmet to more evenly displace weight across the helmet.

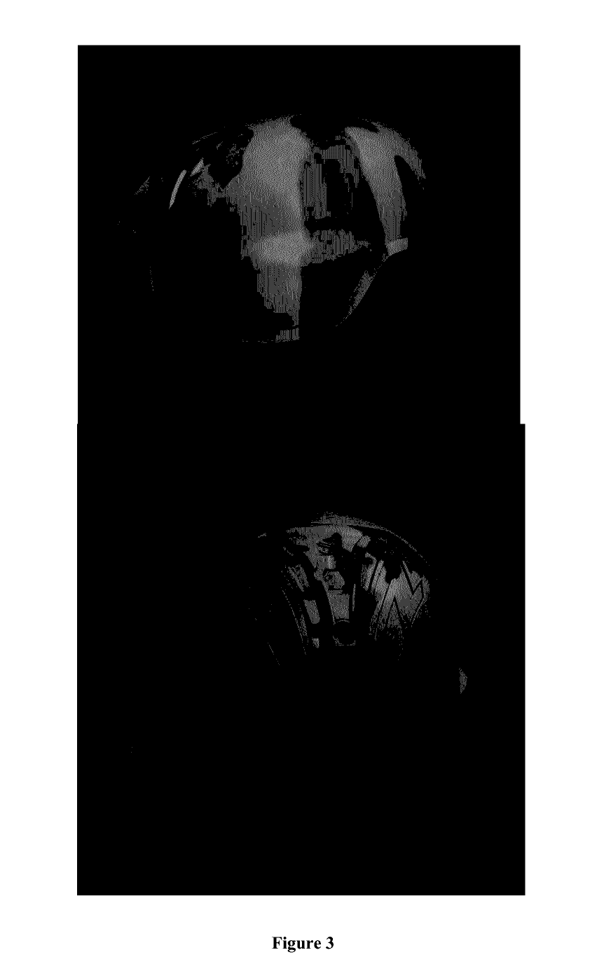

FIG. 3 shows the shovel head counterweight attached to a helmet. As shown in FIG. 3, the shovel head counterweight is contoured to match the curvature of the helmet. Additionally, the shovel head counterweight is typically positioned on the back portion (i.e., back side) of the helmet. However, it is contemplated that the shovel head counterweight is at a position closer to the front portion of the helmet.

FIG. 3 also shows that the shovel head counterweight is typically positioned at the center of the back portion of the helmet. The width of the shovel head counterweight gradually decreases from a first end of the length to a second end of the length. As shown in FIG. 3, the first end is at a higher position than the second end with respect to a vertical axis. Therefore, the first end of the shovel head counterweight having a greater width is typically at a higher position on the helmet than the narrower second end of the shovel head counterweight. However, it is contemplated that a reverse orientation can be used so that the first end of the shovel head counterweight is at a position lower on the helmet than the second position of the shovel head counterweight.

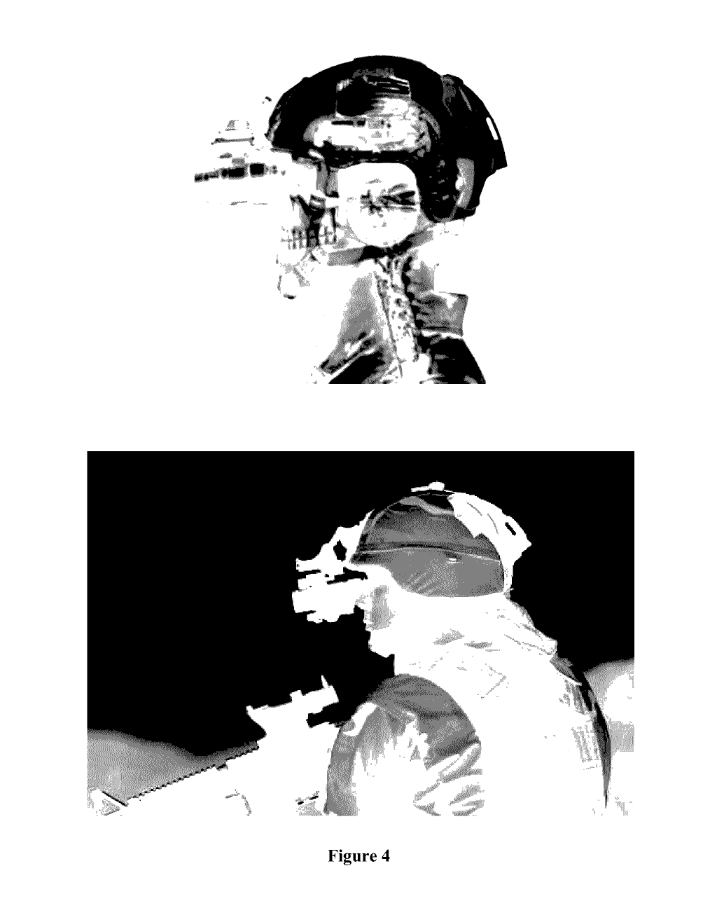

FIG. 4 shows the shovel head counterweight and helmet worn by a user. In this embodiment, the user is also wearing a night vision goggle device. The shovel head counterweight displaces the weight of the night vision goggle device to reduce pain, fatigue, and injury to the user. One should appreciate that it is contemplated that the shovel head counterweight can be manually repositioned on the helmet such that the height of the counterweight can be in one setting to displace the weight of the night vision goggles when worn and the shovel head counterweight can be in a second setting to displace the weight of the night vision goggles when they are not worn (i.e., the night vision goggles are not aligned with the users eyes or at an up position). While the shovel head counterweight is displacing the weight of night vision goggles in this embodiment, it is contemplated that the shovel head counterweight can displace the weight of other devices that are attached to the helmet.

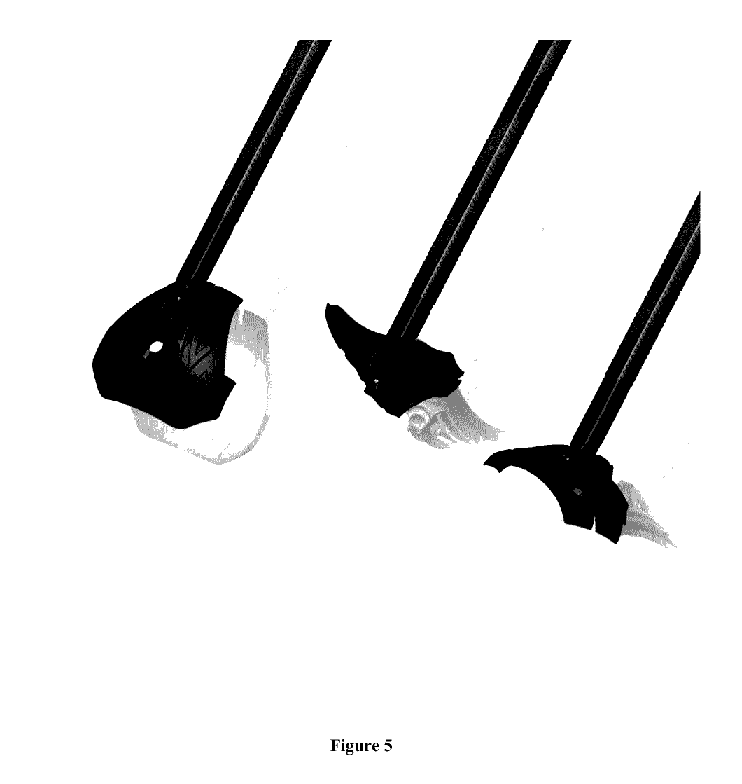

FIG. 5 shows a utility bar attached to a universal fastener of the shovel head counterweight. Utility bars such as those described in U.S. patent application Ser. Nos. 12/427701 and 13/279159 are incorporated herein by reference. The utility bar attaches to the counterweight in three different positions for different applications (e.g., shovel, stand, etc.). In one position, the utility bar can couple to the shovel head counterweight to form a shovel. In another position, the utility bar can couple to shovel head counterweight so that the shovel head counterweight has a curvature towards the utility bar. In a third position, the utility bar can couple to the shovel head counterweight so that the curvature faces opposite to the utility bar.

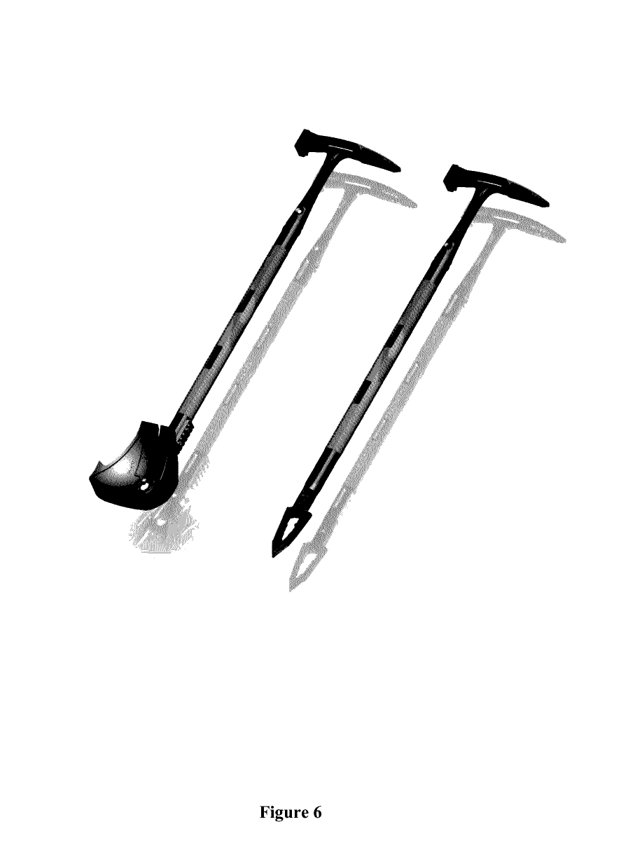

FIG. 6 shows the utility bar attached with the shovel head counterweight at one end and a handle-hammer at the other end, for use as a shovel. FIG. 6 also shows the utility bar attached with a spear head at one end and the handle-hammer at the other end.

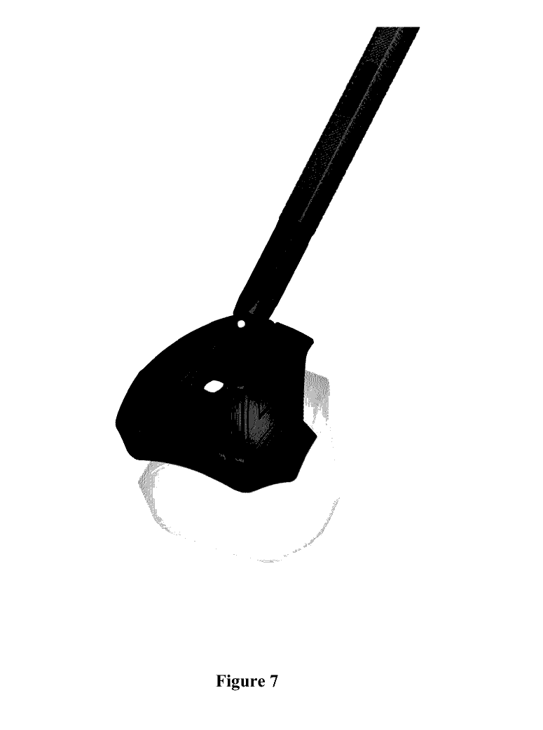

FIG. 7 shows a close up view of the shovel head counterweight attached with a utility bar in the shovel configuration. It should be noted that at least one opening remains on the shovel head counterweight so that another device can couple to the shovel head counterweight.

In some embodiments, the universal fastener on the shovel head counterweight could comprise a vice attachment that grips a feature of the helmet. In other embodiments, the universal fastener could comprise a hook and loop fastener on the helmet and shovel head counterweight. In yet other embodiments, the universal fastener could comprise a threaded engagement.

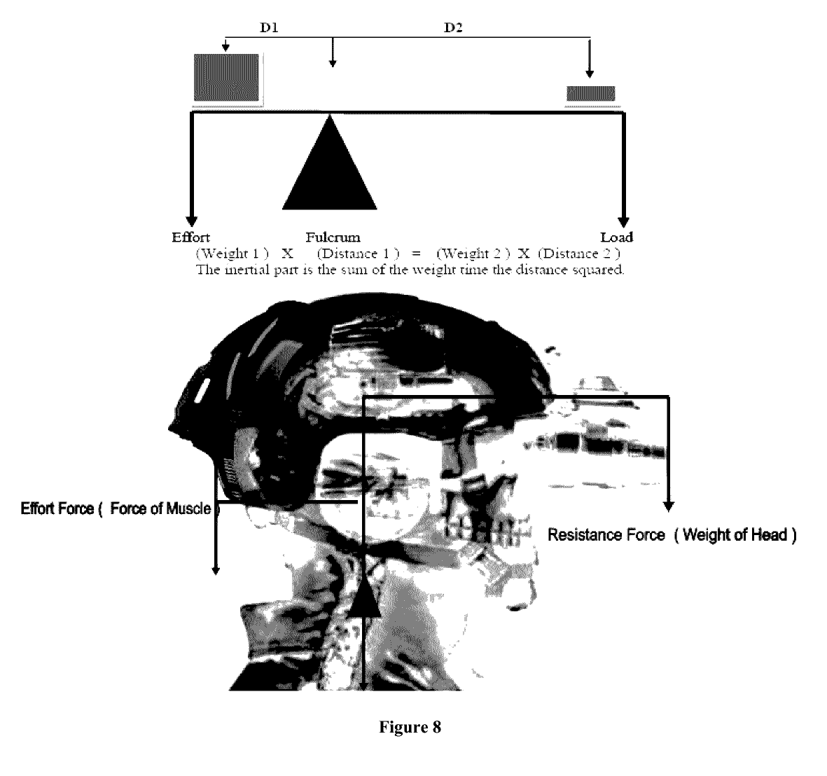

FIG. 8 shows the weight displacement physics of the shovel head counterweight. A lever consists of a rigid “bar” that pivots around a stationary fulcrum in the human body, the fulcrum is the joint axis, bones are the levers, skeletal muscles usually create the basic motion, and resistance can be the weight of a body part, or the weight of an object one is acting upon, combined with the tension of an antagonistic muscle, and so forth. Here the fulcrum lies between the effort and the load. In our bodies, a lever of the first class can be found when the head undergoes nodding movements, i.e. when the occipital condyles articulate with the facets of the atlas. The weight of the face and the head are the resistance. The contraction of the neck muscles is the effort to lift the weight.

As mass properties are added with moments of inertia the lever becomes a compound pendulum. The rotational inertial cares nothing about where it is, above or below the fulcrum, only what its mass is and how far away from the fulcrum it is. The rotational inertia goes up as the square of the distance and wins over leverage. The shovel head counterweight displaces the load and moves the center of gravity to create balance.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A shovel head counterweight for counterbalancing a helmet attachment on a helmet, the helmet having a first curvature and a second curvature, comprising:
a concave member having a first major surface, a second major surface, a length, and a width;
wherein a curvature of the width of the concave member matches the first curvature of the helmet;
wherein a curvature of the length of the concave member matches the second curvature of the helmet;
wherein the width gradually decreases going from a first end of the length to a second end of the length.

2. The shovel head counterweight of claim 1, wherein the concave member has a mass of about 2.1 lbs.

3. The shovel head counterweight of claim 1, wherein the length is about 6.375 inches.

4. The shovel head counterweight of claim 1, wherein the width at the first end is about 6.367 inches.

5. The shovel head counterweight of claim 1, wherein the width at the second end is about 2.663 inches.

6. The shovel head counterweight of claim 1, further comprising a hook and loop fastener attached to the first major surface of the concave member.

7. The shovel head counterweight of claim 1, further comprising a first universal fastener on the second major surface of the concave member for removably attaching a utility bar in a first orientation.

8. The shovel head counterweight of claim 7, further comprising a second universal fastener on the second major surface of the concave member for removably attaching the utility bar in a second orientation.

9. The shovel head counterweight of claim 1, wherein the concave member has a maximum height of about 2.999 inches.

10. The shovel head counterweight of claim 1, wherein the concave member has a sharpened front edge.

11. The shovel head counterweight of claim 10, wherein the concave member has a corrugated side edge for sawing wood.
